(19) United States
(12) Patent Application Publication
(10) Pub. No.: US 2025/0296484 A1
(43) Pub. Date: Sep. 25, 2025

(54) VEHICLE SEAT AND CUSHION FRAME

(71) Applicant: TOYOTA BOSHOKU KABUSHIKI KAISHA, Aichi (JP)

(72) Inventor: Yuki NAGATANI, Kasugai-shi (JP)

(73) Assignee: TOYOTA BOSHOKU KABUSHIKI KAISHA, Aichi (JP)

(21) Appl. No.: 19/077,683

(22) Filed: Mar. 12, 2025

(30) Foreign Application Priority Data
Mar. 19, 2024 (JP) 2024-043482

(51) Int. Cl. B60N 2/16

(52) U.S. Cl. CPC B60N 2/1615

(57) ABSTRACT

A cushion frame of the present disclosure includes a first side frame, a second side frame, a first coupling member, a second coupling member, and a reinforcing frame. When a center of the first coupling member projected onto an imaginary plane perpendicular to the seat-width direction is referred to as a first center, a center of the second coupling member projected onto the imaginary plane is referred to as a second center, and a midpoint between the first center and the second center is referred to as a center point, a front end of the reinforcing frame projected onto the imaginary plane is located frontward of the center point, and at least part of the second coupling member projected onto the imaginary plane overlaps with the reinforcing frame projected onto the imaginary plane.

### CROSS-REFERENCE TO RELATED APPLICATIONS

This application claims the benefit of Japanese Patent Application No. 2024-043482 filed on Mar. 19, 2024 with the Japan Patent Office, the entire disclosure of which is incorporated herein by reference.

### BACKGROUND

The present disclosure relates to a vehicle seat and a cushion frame to be applied to the vehicle seat.

For example, in a cushion frame disclosed in Japanese Unexamined Patent Application Publication No. 2019-73184, a patch for reinforcement is attached to part of the side frame.

### SUMMARY

In the event of a collision or the like, an inertial force to act on an occupant of a seat is input to a back frame, and thus, a large moment is generated in the cushion frame coupled to a base of the back frame. The present disclosure discloses an example of a cushion frame with this point taken into consideration.

It is desirable that a cushion frame that is to be applied to a vehicle seat and to which a back frame is to be coupled at a rear end part of the cushion frame comprise at least one of the elements described below, for example.

Specifically, such elements are: a first side frame arranged on a first end side in a seat-width direction, the first side frame extending in a seat front-rear direction; a second side frame arranged on a second end side in the seat-width direction, the second side frame extending in the seat front-rear direction; a first coupling member extending in the seat-width direction, the first coupling member coupling a front-side part of the first side frame and a front-side part of the second side frame to each other; a second coupling member extending in the seat-width direction, the second coupling member coupling a rear-side part of the first side frame and a rear-side part of the second side frame to each other; and a reinforcing frame fixed to the first side frame, the reinforcing frame reinforcing the first side frame.

Moreover, it is desirable that a front end of the reinforcing frame projected onto an imaginary plane be located frontward of a center point, and that at least part of the second coupling member projected onto the imaginary plane overlap with the reinforcing frame projected onto the imaginary plane.

The imaginary plane is an imaginary plane perpendicular to the seat-width direction. The center point refers to a midpoint between a first center and a second center. The first center refers to a center of the first coupling member projected onto the imaginary plane. The second center refers to a center of the second coupling member projected onto the imaginary plane.

Thus, even in a case where an inertial force to act on the occupant is input to the back frame to generate a large moment in the cushion frame, the cushion frame can resist such a moment.

Furthermore, the center of a load acting on the cushion frame due to the occupant's own weight and so on is usually located between the first center and the second center. Thus, the cushion frame can also resist such a load effectively.

The cushion frame may have a configuration described below, for example. Specifically, it is desirable that the first coupling member and the second coupling member be each rotatably coupled to the first side frame and to the second side frame; that the cushion frame further comprise: a first lifter link configured to rotate integrally with the first coupling member, the first lifter link extending in a direction perpendicular to a longitudinal direction of the first coupling member; a second lifter link configured to rotate integrally with the second coupling member, the second lifter link extending in a direction perpendicular to a longitudinal direction of the second coupling member; a sector gear configured to rotate integrally with the second coupling member; and an electric motor arranged on a side opposite where the sector gear is located, with the first side frame interposed therebetween, the electric motor being configured to generate a driving force to rotate the sector gear, that the reinforcing frame be arranged between the first side frame and the sector gear, and that the reinforcing frame be provided with a displacement restricting part protruding toward the sector gear.

This allows the sector gear to be restricted from being displaced beyond a predetermined position, in the cushion frame.

It is desirable that the cushion frame further comprise: a first flange provided on a first end part, in an up-down direction, of the first side frame, the first flange protruding from the first end part in the seat-width direction; and a second flange provided on a part of the reinforcing frame on a side opposite, in the up-down direction, where the first flange is located, the second flange protruding from said part in the seat-width direction, and that, when a position where the electric motor is fixed to the first side frame is referred to as a motor fixing position, the motor fixing position projected onto an imaginary horizontal plane be located inside an outer edge of the second flange projected onto the imaginary horizontal plane.

This makes it possible to inhibit a large change in stiffness in the motor fixing position, and thus, stress concentration may be less likely to occur in the motor fixing position. As a result, induction of deformation centered on the motor fixing position can be inhibited.

Additionally, it is desirable that the second flange protrude in a direction opposite to a protruding direction of the first flange. This allows a neutral point to be positioned in a portion where a member is present. Thus, the stiffness can be ensured effectively.

In a case where the cross section is C-shaped, the neutral point is positioned in a portion where no member is present. On the other hand, in a case where the cross section is Z-shaped or H-shaped, the neutral point is positioned in a portion where a member is present. Such a structure in which the neutral point is positioned in a portion where a member is present makes it possible to ensure the stiffness effectively.

### BRIEF DESCRIPTION OF THE DRAWINGS

An example embodiment of the present disclosure will be described below with reference to the accompanying drawings, in which:

FIG. 1 is a diagram showing a vehicle seat according to a first embodiment;

FIG. 2 is a diagram showing a cushion frame according to the first embodiment;

FIG. 3 is a diagram showing the cushion frame according to the first embodiment;

FIG. 4 is a partially enlarged view of the cushion frame according to the first embodiment;

FIG. 5 is an exploded view of a structure related to a first side frame according to the first embodiment;

FIG. 6 is a diagram showing the first side frame and so on according to the first embodiment;

FIG. 7 is a diagram showing the first side frame and so on according to the first embodiment;

FIG. 8 is a diagram showing a first reinforcing frame according to the first embodiment;

FIG. 9 is a diagram showing the first side frame and so on according to the first embodiment;

FIG. 10 is a diagram showing the first side frame and so on according to the first embodiment;

FIG. 11 is a diagram showing the first side frame and so on according to the first embodiment; and

FIG. 12 is a diagram showing the first side frame and so on according to the first embodiment.

### DETAILED DESCRIPTION OF EXEMPLARY EMBODIMENTS

Below-described “embodiments of the invention” show examples of the embodiments that fall within the technical scope of the present disclosure. That is, invention-specifying matters and so on recited in the appended claims are not limited by specific configurations, structures, and so on indicated in the embodiments below.

The embodiments below are examples of a cushion frame in a seat to be mounted in a vehicle (hereinafter referred to as a vehicle seat), such as an automobile. Arrows indicating directions, hatched lines, and so on shown in the drawings are provided for the purpose of easier understanding of mutual relationships between the drawings, shapes of members or portions, and so on.

The cushion frame is not limited by the directions shown in the drawings. The directions shown in the drawings are directions in a state where the vehicle seat according to the embodiments below is mounted in the automobile. The drawings provided with hatched lines do not necessarily represent sectional views.

A member or a portion described at least with a reference numeral is at least one in number except in a case of being accompanied by a restrictive wording such as “only one”. In other words, the member or the portion may be two or more in number in a case of not being accompanied by the restrictive wording such as “only one”. The cushion frame indicated in the present disclosure comprises at least one of (i) an element such as the member or the portion described at least with a reference numeral or (ii) a structural portion shown in the drawings.

### First Embodiment

### <1. Overview of Vehicle Seat>

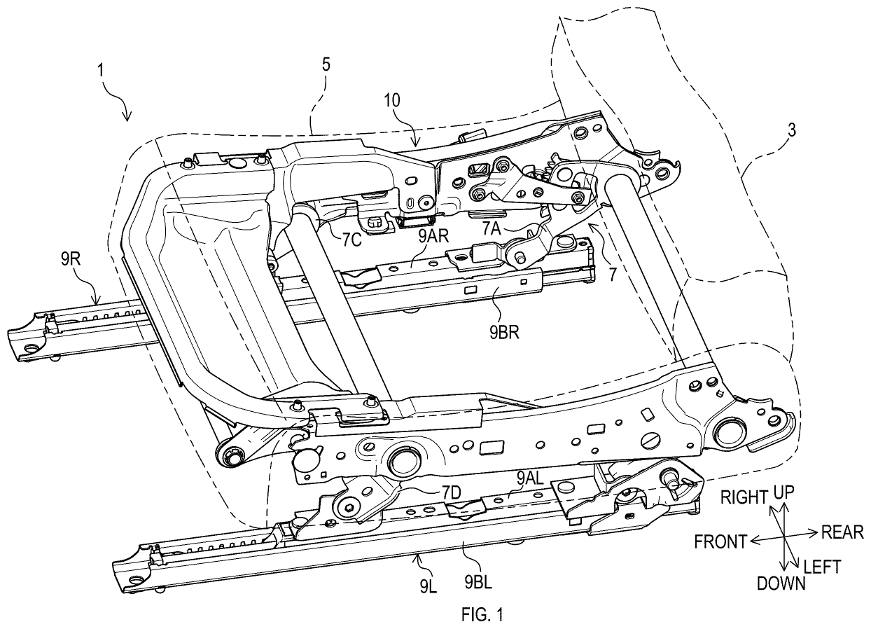

As shown in FIG. 1, a vehicle seat 1 comprises a seatback 3, a seat cushion 5, a lifter device 7, and sliding devices 9R and 9L. The seatback 3 supports an occupant's back. The seat cushion 5 supports the occupant's buttocks.

The lifter device 7 is a mechanism for displacing the seat cushion 5 in an up-down direction. The sliding devices 9R and 9L constitute a mechanism for enabling sliding displacement of the seat cushion 5 in a seat front-rear direction.

The seatback 3 comprises a back frame (not shown) and a cushion member (not shown). The back frame forms a framework of the seatback 3. The cushion member is formed of an elastically deformable material, such as urethane.

The seat cushion 5 comprises a cushion frame 10 and a cushion member (not shown). The cushion frame 10 forms a framework of the seat cushion 5. The cushion member is formed of an elastically deformable material, such as urethane. The lifter device 7 may be understood to be provided to the cushion frame 10.

### <2. Details of Cushion Frame, Lifter Device, and so On>

### <2.1 Configuration of Cushion Frame>

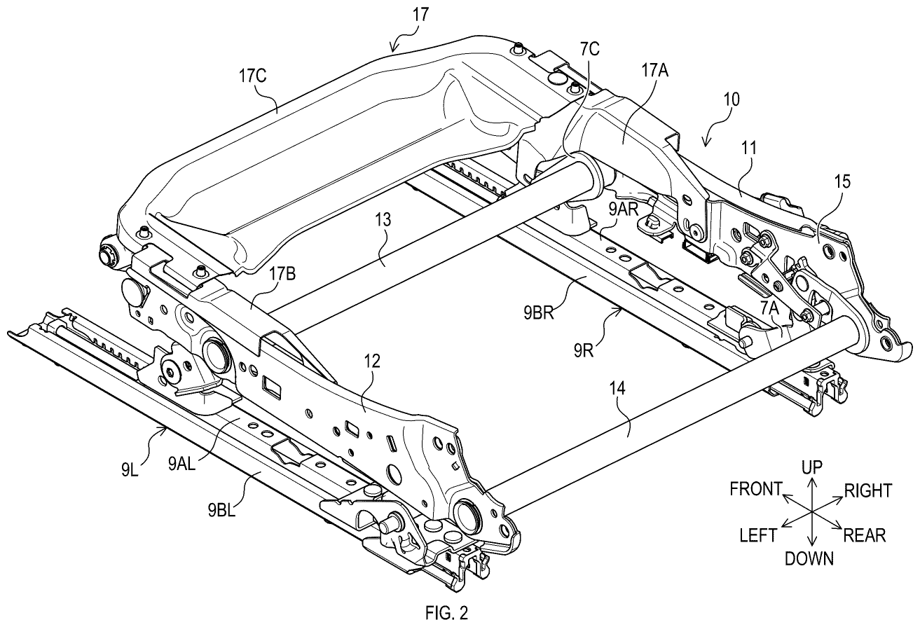

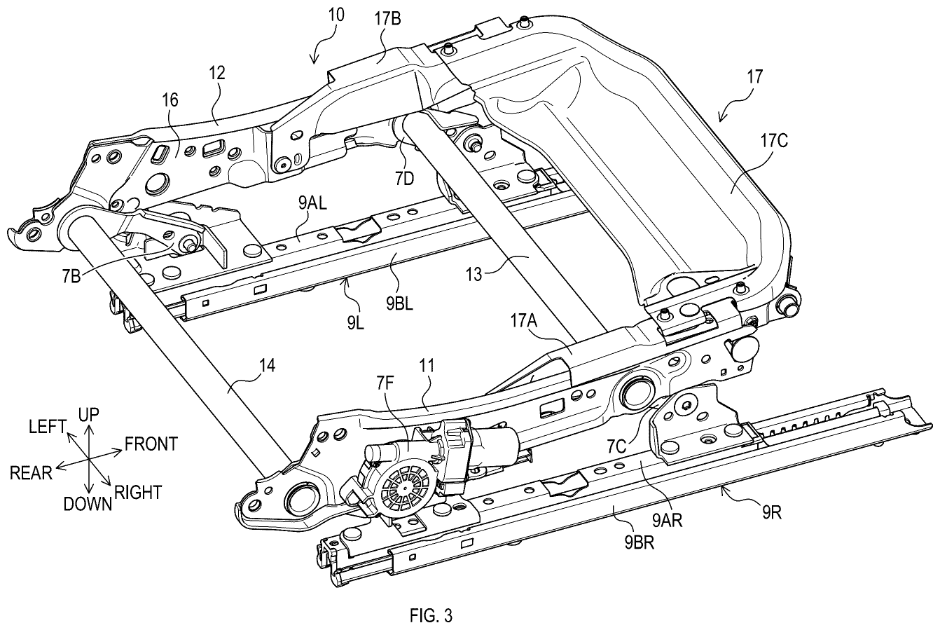

As shown in FIGS. 2 and 3, the cushion frame 10 comprises a first side frame 11, a second side frame 12, a front pipe 13, a rear pipe 14, a first reinforcing frame 15, and a second reinforcing frame 16.

The first side frame 11 is a high-strength member that is arranged on a first end side in a seat-width direction and that extends in the seat front-rear direction. The second side frame 12 is a high-strength member that is arranged on a second end side in the seat-width direction and that extends in the seat front-rear direction.

The front pipe 13 is one example of a first coupling member that extends in the seat-width direction and that couples a front-side part of the first side frame 11 and a front-side part of the second side frame 12 to each other. The rear pipe 14 is one example of a second coupling member that extends in the seat-width direction and that couples a rear-side part of the first side frame 11 and a rear-side part of the second side frame 12 to each other.

The front pipe 13 and the rear pipe 14 are each rotatably coupled to the first side frame 11 and to the second side frame 12. In other words, the front pipe 13 and the rear pipe 14 are each rotatable about a central axis thereof parallel to the seat-width direction.

The first reinforcing frame 15 is a reinforcing member fixed to the first side frame 11 to reinforce the first side frame 11. The second reinforcing frame 16 is a reinforcing member fixed to the second side frame 12 to reinforce the second side frame 12.

The first reinforcing frame 15 is fixed to the first side frame 11 by welding (by spot welding, in the present embodiment). The second reinforcing frame 16 is fixed to the second side frame 12 by welding (by spot welding, in the present embodiment).

The back frame is coupled to rear end parts of the first side frame 11 and the second side frame 12 directly or indirectly. The back frame may be fixed to a rear end part of the cushion frame 10 via a recliner (not shown) or the like.

As shown in FIG. 2, the cushion frame 10 also comprises a tilt mechanism 17. The tilt mechanism 17 is a mechanism for changing an angle of a front end part of the seat cushion 5.

The tilt mechanism 17 comprises tilt arms 17A and 17B, a front panel 17C, and an actuator (not shown). The tilt arm 17A extends in the seat front-rear direction, and its rear end part is rotatably coupled to the first side frame 11.

The tilt arm 17B extends in the seat front-rear direction, and its rear end part is rotatably coupled to the second side frame 12. The front panel 17C is a panel-shaped member that couples front end parts of the tilt arms 17A and 17B to each other.

The actuator generates a force to cause the tilt arms 17A and 17B to be pivotally displaced with respect to the first side frame 11 and the second side frame 12, respectively. Thus, upon activation of the actuator, the angle of the front end part of the seat cushion 5 changes.

### <2.2 Lifter Device>

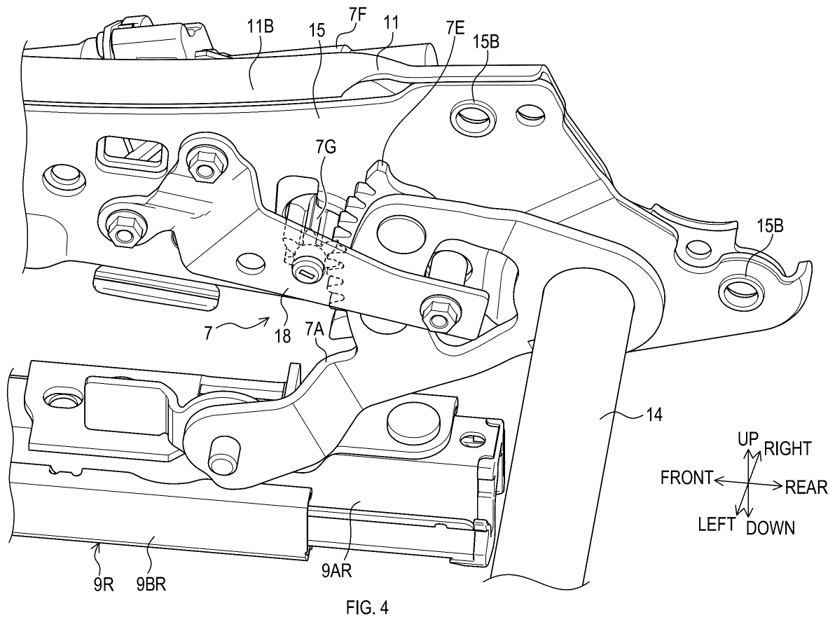

As shown in FIGS. 1 to 4, the lifter device 7 comprises first lifter links 7C and 7D, second lifter links 7A and 7B, a sector gear 7E (see FIG. 4), and an electric motor 7F (see FIG. 3).

The first lifter links 7C and 7D, which are fixed to the front pipe 13 at their upper end parts, extend in a direction perpendicular to a longitudinal direction of the front pipe 13 and rotate integrally with the front pipe 13.

The first lifter link 7C is fixed to the front pipe 13 on a side where the first side frame 11 is located. The first lifter link 7D is fixed to the front pipe 13 on a side where the second side frame 12 is located.

The second lifter links 7A and 7B, which are fixed to the rear pipe 14 at their upper end parts, extend in a direction perpendicular to a longitudinal direction of the rear pipe 14 and rotate integrally with the rear pipe 14.

The second lifter link 7A is fixed to the rear pipe 14 on the side where the first side frame 11 is located. The second lifter link 7B is fixed to the rear pipe 14 on the side where the second side frame 12 is located.

As shown in FIGS. 1 to 3, lower end parts of the first lifter link 7C and the second lifter link 7A are rotatably coupled to a movable rail 9AR of the sliding device 9R, and lower end parts of the first lifter link 7D and the second lifter link 7B are rotatably coupled to a movable rail 9AL of the sliding device 9L.

In other words, the lower end parts of the lifter links 7A and 7C are coupled to the sliding device 9R arranged on the side where the first side frame 11 is located, and the lower end parts of the lifter links 7B and 7D are coupled to the sliding device 9L arranged on the side where the second side frame 12 is located.

The sliding device 9R is configured with the movable rail 9AR and a fixed rail 9BR, and the sliding device 9L is configured with the movable rail 9AL and a fixed rail 9BL. The fixed rails 9BR and 9BL are rail members to be fixed to a vehicle directly or indirectly. The movable rails 9AR and 9AL are members slidable with respect to the fixed rails 9BR and 9BL, respectively.

As shown in FIG. 4, the sector gear 7E rotates integrally with the rear pipe 14. The sector gear 7E is fixed to the second lifter link 7A and rotates integrally with the rear pipe 14, together with the second lifter link 7A.

The electric motor 7F is an actuator that generate a driving force to rotate the sector gear 7E. The electric motor 7F is arranged on a side opposite where the sector gear 7E is located, with the first side frame 11 interposed therebetween.

The sector gear 7E and the first reinforcing frame 15 are arranged on a side closer to the second side frame 12 is located, with respect to the first side frame 11 (hereinafter referred to as an inner side of the first side frame 11). A side opposite the inner side with respect to the first side frame 11 is hereinafter referred to as an outer side.

The first reinforcing frame 15 is arranged on the inner side of the first side frame 11 and between the first side frame 11 and the sector gear 7E. The electric motor 7F is arranged on the outer side of the first side frame 11.

An output shaft of the electric motor 7F passes through the first side frame 11 and the first reinforcing frame 15 to reach the inner side. The output shaft is provided with a pinion 7G that meshes with the sector gear 7E. A leading end of the output shaft is supported by a bracket 18.

### <Details of First Side Frame and First Reinforcing Frame>

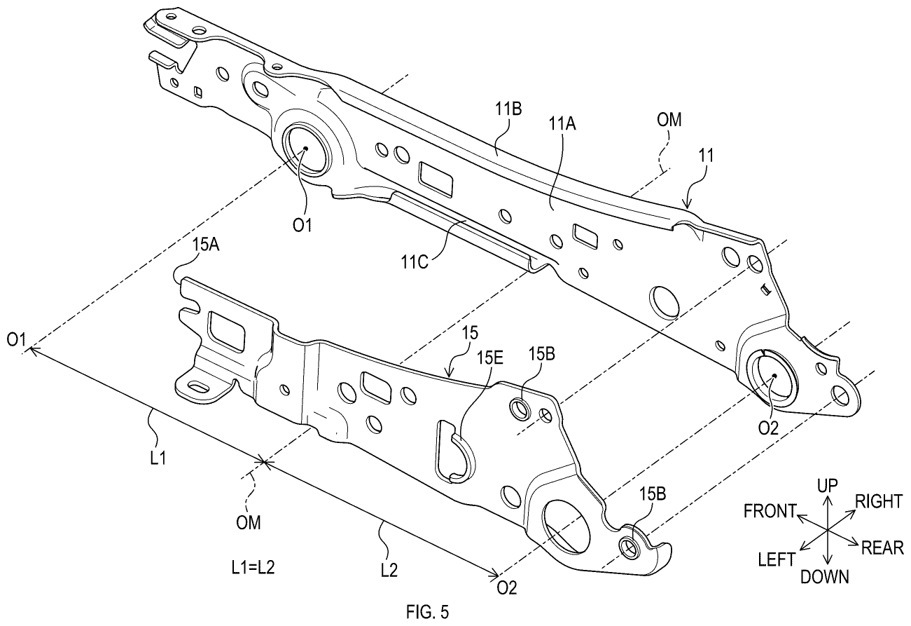

As shown in FIG. 5, the first reinforcing frame 15 is arranged on the inner side of the first side frame 11 (on the left side in FIG. 5). The first side frame 11 comprises a plate portion 11A and first flanges 11B and 11C.

The plate portion 11A is a wall-like portion perpendicular to the seat-width direction. The first flanges 11B and 11C are wall-like protruding portions protruding in the seat-width direction. The first flanges 11B and 11C are provided at least between a first center O1 and a second center O2.

The first center O1 refers to a center of the front pipe 13 projected onto an imaginary plane perpendicular to the seat-width direction (hereinafter referred to as an imaginary vertical plane). The second center O2 refers to a center of the rear pipe 14 projected onto the imaginary vertical plane. A midpoint between the first center O1 and the second center O2 is referred to as a center point OM.

The first flange 11B protrudes from an upper end part of the plate portion 11A toward the inner side (the left side in FIG. 5). The first flange 11C protrudes from a lower end part of the plate portion 11A toward the inner side (the left side in FIG. 5).

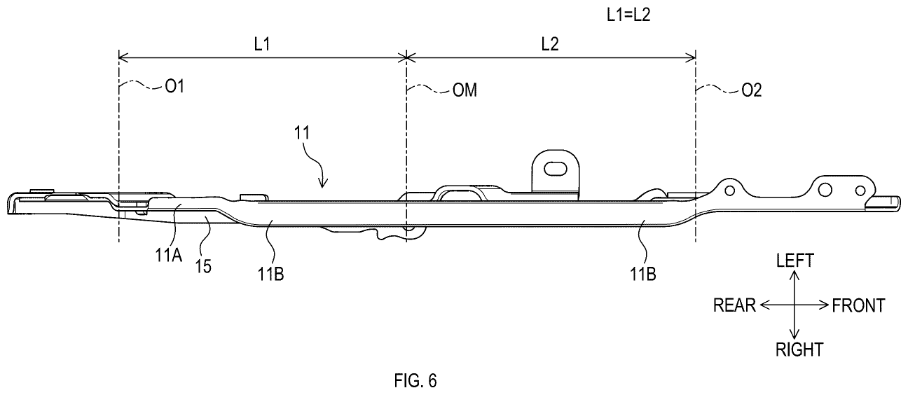

The first flange 11B projected onto an imaginary horizontal plane includes the center point OM projected onto the imaginary horizontal plane (see FIG. 6). A rear end of the first flange 11C projected onto the imaginary horizontal plane is substantially coincident with the center point OM projected onto the imaginary horizontal plane (see FIG. 5).

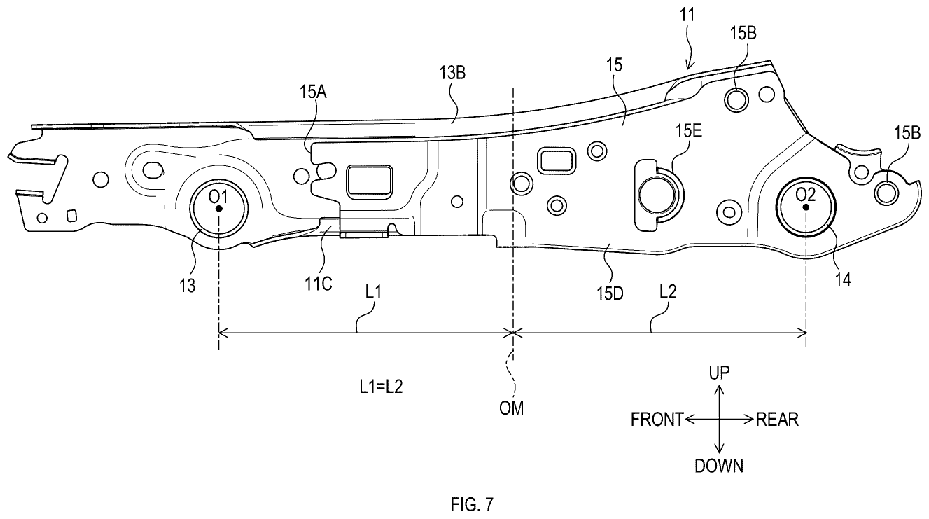

As shown in FIG. 7, a front end 15A of the first reinforcing frame 15 projected onto the imaginary vertical plane is located frontward of the center point OM, and at least part of the rear pipe 14 projected onto the imaginary vertical plane overlaps with the first reinforcing frame 15 projected onto the imaginary vertical plane.

A rear end of the first reinforcing frame 15 is substantially coincident with a rear end of the first side frame 11. Thus, the first reinforcing frame 15 is provided with a female thread part 15B for fixing the back frame by fastening.

The female thread part 15B is a part in which a female thread is formed on an inner circumferential surface of a cylindrical part. The cylindrical part is a part formed by applying a burring process to a plate material. A bolt (not shown) for fixing the back frame by fastening passes through the first side frame 11 and is screwed into the female thread part 15B of the first reinforcing frame 15.

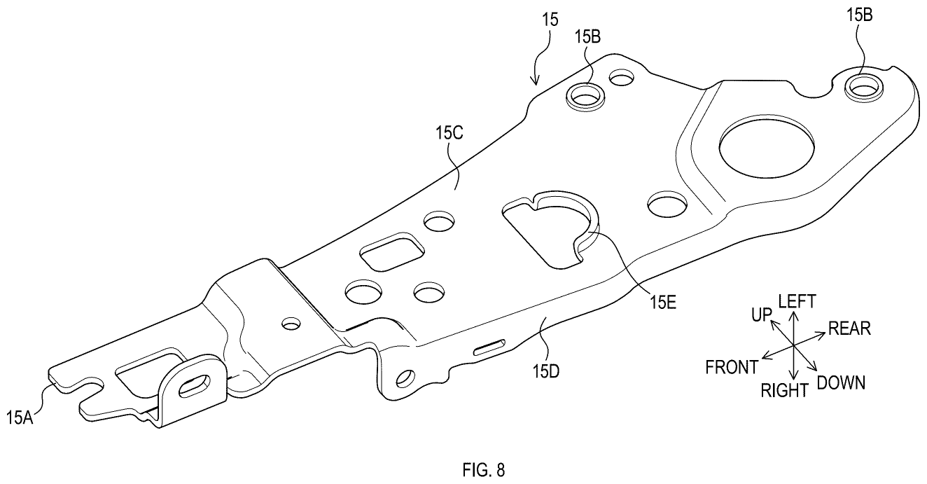

As shown in FIG. 8, the first reinforcing frame 15 comprises a plate portion 15C and a second flange 15D. The plate portion 15C is a wall-like portion perpendicular to the seat-width direction. The second flange 15D is a wall-like protruding portion protruding in the seat-width direction.

In the first reinforcing frame 15, the second flange 15D is provided on a side, in the up-down direction, opposite where the first flange 11B is located. Specifically, the second flange 15D is provided on a lower end side of the first reinforcing frame 15.

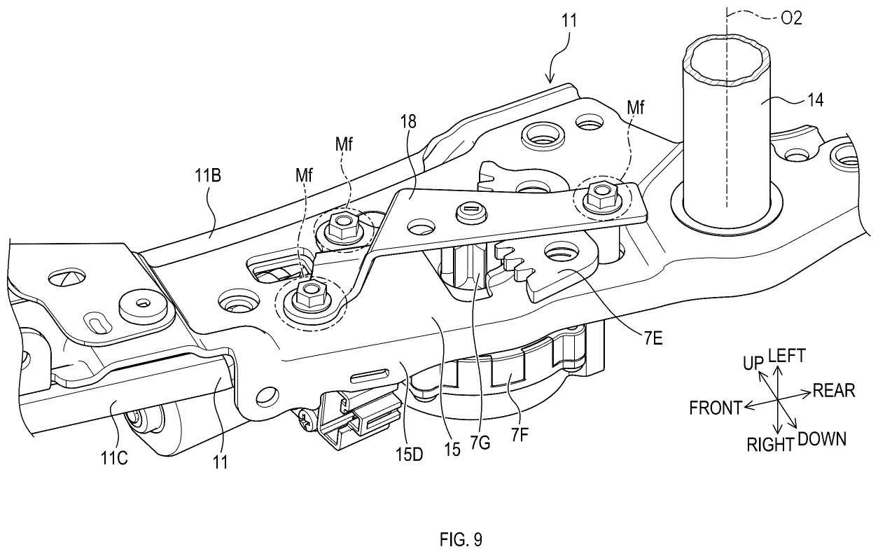

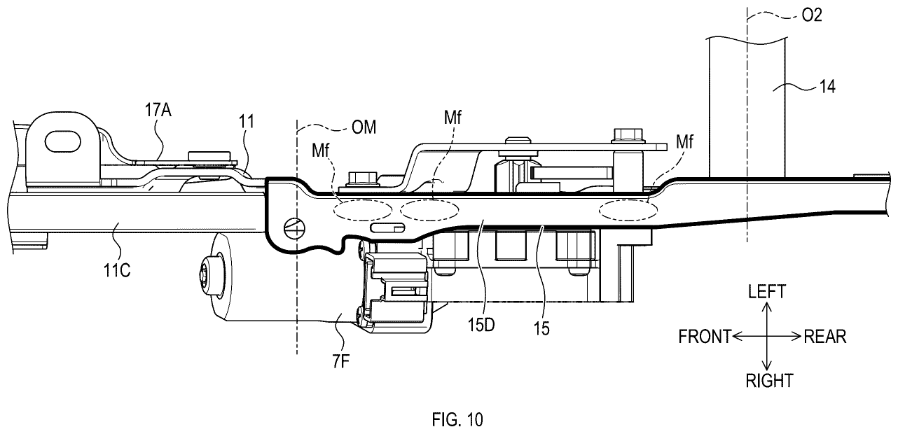

As shown in FIG. 10, motor fixing positions Mf projected onto the imaginary horizontal plane are located inside an outer edge of the second flange 15D projected onto the imaginary horizontal plane (inside of a thick solid line in FIG. 10). The motor fixing positions Mf refer to positions, in the first side frame 11, where the electric motor 7F is fixed (see FIG. 9).

The second flange 15D projected onto the imaginary vertical plane is continuous in a range at least from the center point OM to the second center O2. In other words, the first flange 11C and the second flange 15D projected onto the imaginary vertical plane cooperatively form a flange ranging from the first center O1 to the second center O2.

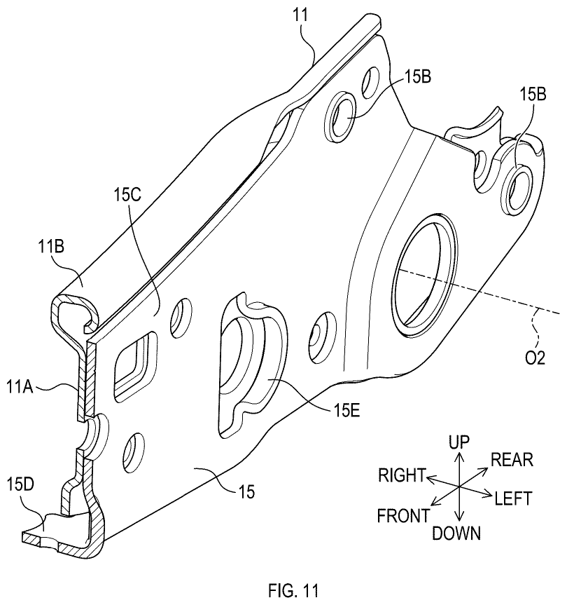

As shown in FIG. 11, the second flange 15D protrudes in a direction opposite to a protruding direction of the first flange 11B. Specifically, while the first flange 11B is provided on an upper end side of the first side frame 11, the second flange 15D is provided to a part on a lower end side of the first side frame 11, where the first flange 11C is not present.

The first flange 11B protrudes from the plate portion 11A toward the inner side (the left side in the present embodiment). The second flange 15D protrudes from the plate portion 15C toward the outside (the right side in the present embodiment).

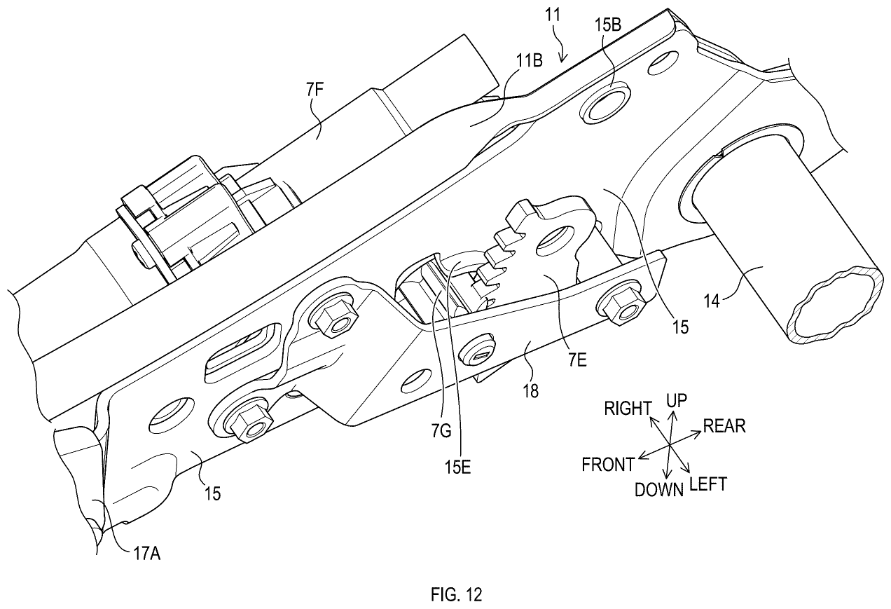

As shown in FIG. 12, the first reinforcing frame 15 is provided with a displacement restricting part 15E. The displacement restricting part 15E protrudes toward the sector gear 7E to restrict the sector gear 7E from being displaced toward the first side frame 11 beyond a predetermined position.

The displacement restricting part 15E is formed by applying a burring process to the plate portion 15C. The first reinforcing frame 15 is also provided with other functional parts, such as a pivot axis part for the tilt arm 17A and a harness supporting part, in addition to the displacement restricting part 15E and the female thread part 15B.

The second side frame 12 and the second reinforcing frame 16 are generally the same in configuration as, respectively, the first side frame 11 and the first reinforcing frame 15, except that the electric motor 7F and the sector gear 7E, the second flange 15D, and so on are not provided.

### <3. Characteristic Features of Cushion Frame>

As shown in FIG. 7, the front end 15A of the first reinforcing frame 15 is located frontward of the center point OM, and at least part of the rear pipe 14 projected onto the imaginary vertical plane overlaps with the first reinforcing frame 15 projected onto the imaginary vertical plane.

Thus, even in a case where an inertial force to act on the occupant is input to the back frame to generate a large moment in the cushion frame 10, the cushion frame 10 can resist such a moment.

Moreover, the center of a load acting on the cushion frame 10 due to the occupant's own weight and so on is usually located between the first center O1 and the second center O2. Thus, the cushion frame 10 can also resist such a load effectively.

The first reinforcing frame 15 is provided with the displacement restricting part 15E protruding toward the sector gear 7E. This allows the sector gear 7E to be restricted from being displaced beyond the predetermined position, in the cushion frame 10.

As shown in FIG. 10, the motor fixing positions Mf projected onto the imaginary horizontal plane are located inside the outer edge of the second flange 15D projected onto the imaginary horizontal plane. This makes it possible to inhibit a large change in stiffness in the motor fixing positions Mf. Thus, stress concentration may be less likely to occur in the motor fixing positions Mf. As a result, induction of deformation centered on each motor fixing position Mf can be inhibited.

If a configuration is employed in which the stiffness changes greatly in the motor fixing positions Mf, stress is likely to concentrate on the motor fixing positions Mf, which may induce a large deformation centered on each motor fixing position Mf.

Furthermore, as shown in FIG. 11, the second flange 15D protrudes in the direction opposite to the protruding direction of the first flange 11B. This allows a neutral point to be positioned in a portion where a member is present. Thus, the stiffness can be ensured effectively.

### OTHER EMBODIMENTS

The rear end of the first reinforcing frame 15 of the above-described embodiment is substantially coincident with the rear end of the first side frame 11. However, the present disclosure is not limited to this. For example, a configuration may be employed in which the rear end of the first reinforcing frame 15 is coincident with the rear end of the rear pipe 14.

The first reinforcing frame 15 of the above-described embodiment is provided with the displacement restricting part 15E, the female thread part 15B, the pivot axis part for the tilt arm 17A, the harness supporting part, and so on. However, the present disclosure is not limited to this. The first reinforcing frame 15 in which some of these elements are omitted may be employed.

In the above-described embodiment, as shown in FIG. 10, the motor fixing positions Mf projected onto the imaginary horizontal plane are located inside the outer edge of the second flange 15D projected onto the imaginary horizontal plane. However, the present disclosure is not limited to this. For example, the motor fixing positions Mf projected onto the imaginary horizontal plane may be located outside the outer edge of the second flange 15D projected onto the imaginary horizontal plane.

In the above-described embodiment, the second flange 15D protrudes in the direction opposite to the protruding direction of the first flange 11B. However, the present disclosure is not limited to this. For example, a configuration may be employed in which the second flange 15D protrudes in the same direction as the protruding direction of the first flange 11B.

In the above-described embodiment, the first flange 11B protrudes toward the inner side. However, the present disclosure is not limited to this. For example, a configuration may be employed in which the first flange 11B protrudes toward the outer side.

The sector gear 7E of the above-described embodiment is fixed to the second lifter link 7A, and is configured to rotate integrally with the rear pipe 14, together with the second lifter link 7A. However, the present disclosure is not limited to this. For example, a configuration may be employed in which the sector gear 7E is fixed directly to the rear pipe 14.

In the above-described embodiment, the first end side in the seat-width direction corresponds to a right end side of the seat, and the second end side in the seat-width direction corresponds to a left end side of the seat. However, the present disclosure is not limited to this. For example, a configuration may be employed in which the first end side in the seat-width direction corresponds to the left end side of the seat and in which the second end side in the seat-width direction corresponds to the right end side of the seat.

In the above-described embodiments, the vehicle seat according to the present disclosure is applied to the automobile. However, application of the disclosure disclosed herein is not limited thereto. The present disclosure is also applicable to, for example, a seat used in vehicles, such as railroad vehicles, ships, or aircraft, and to a stationary seat used in theaters, at home, or in other places.

Moreover, it is sufficient that the present disclosure be consistent with the gist of the disclosure described in the above-described embodiments, and the present disclosure is not limited to the above-described embodiments. Therefore, a configuration may be employed in which at least two embodiments among the above-described embodiments are combined together or in which any of the elements shown in the drawings or the elements described with reference numerals is removed in the above-described embodiments.

What is claimed is:

1. A cushion frame that is to be applied to a vehicle seat and to which a back frame is to be coupled at a rear end part of the cushion frame, the cushion frame comprising:
a first side frame arranged on a first end side in a seat-width direction, the first side frame extending in a seat front-rear direction;
a second side frame arranged on a second end side in the seat-width direction, the second side frame extending in the seat front-rear direction;
a first coupling member extending in the seat-width direction, the first coupling member coupling a front-side part of the first side frame and a front-side part of the second side frame to each other;
a second coupling member extending in the seat-width direction, the second coupling member coupling a rear-side part of the first side frame and a rear-side part of the second side frame to each other; and
a reinforcing frame fixed to the first side frame, the reinforcing frame reinforcing the first side frame,
wherein, when a center of the first coupling member projected onto an imaginary plane perpendicular to the seat-width direction is referred to as a first center, a center of the second coupling member projected onto the imaginary plane is referred to as a second center, and a midpoint between the first center and the second center is referred to as a center point, a front end of the reinforcing frame projected onto the imaginary plane is located frontward of the center point, and at least part of the second coupling member projected onto the imaginary plane overlaps with the reinforcing frame projected onto the imaginary plane.

2. The cushion frame according to claim 1,
wherein the first coupling member and the second coupling member are each rotatably coupled to the first side frame and to the second side frame,
wherein the cushion frame further comprises:
a first lifter link configured to rotate integrally with the first coupling member, the first lifter link extending in a direction perpendicular to a longitudinal direction of the first coupling member;
a second lifter link configured to rotate integrally with the second coupling member, the second lifter link extending in a direction perpendicular to a longitudinal direction of the second coupling member;
a sector gear configured to rotate integrally with the second coupling member; and
an electric motor arranged on a side opposite where the sector gear is located, with the first side frame interposed therebetween, the electric motor being configured to generate a driving force to rotate the sector gear,
wherein the reinforcing frame is arranged between the first side frame and the sector gear, and
wherein the reinforcing frame is provided with a displacement restricting part protruding toward the sector gear to restrict the sector gear from being displaced beyond a predetermined position.

3. The cushion frame according to claim 2, further comprising:
a first flange provided on a first end part, in an up-down direction, of the first side frame, the first flange protruding from the first end part in the seat-width direction; and
a second flange provided on a part of the reinforcing frame on a side opposite, in the up-down direction, where the first flange is located, the second flange protruding from said part in the seat-width direction,
wherein, when a position where the electric motor is fixed to the first side frame is referred to as a motor fixing position, the motor fixing position projected onto an imaginary horizontal plane is located inside an outer edge of the second flange projected onto the imaginary horizontal plane.

4. The cushion frame according to claim 3,
wherein the second flange protrudes in a direction opposite to a protruding direction of the first flange.

5. A vehicle seat including a cushion frame and a back frame that form a framework of the vehicle seat, the back frame being coupled to a rear end part of the cushion frame,
the cushion frame comprising:
a first side frame arranged on a first end side in a seat-width direction, the first side frame extending in a seat front-rear direction;
a second side frame arranged on a second end side in the seat-width direction, the second side frame extending in the seat front-rear direction;
a first coupling member extending in the seat-width direction, the first coupling member coupling a front-side part of the first side frame and a front-side part of the second side frame to each other;
a second coupling member extending in the seat-width direction, the second coupling member coupling a rear-side part of the first side frame and a rear-side part of the second side frame to each other; and
a reinforcing frame fixed to the first side frame, the reinforcing frame reinforcing the first side frame,
wherein, in the cushion frame, when a center of the first coupling member projected onto an imaginary plane perpendicular to the seat-width direction is referred to as a first center, a center of the second coupling member projected onto the imaginary plane is referred to as a second center, and a midpoint between the first center and the second center is referred to as a center point, a front end of the reinforcing frame projected onto the imaginary plane is located frontward of the center point, and at least part of the second coupling member projected onto the imaginary plane overlaps with the reinforcing frame projected onto the imaginary plane.

6. The vehicle seat according to claim 5,
wherein the first coupling member and the second coupling member are each rotatably coupled to the first side frame and to the second side frame,
wherein the vehicle seat includes a lifter device configured to displace a seat cushion including the cushion frame,
wherein the lifter device includes:
a first lifter link configured to rotate integrally with the first coupling member, the first lifter link extending in a direction perpendicular to a longitudinal direction of the first coupling member;
a second lifter link configured to rotate integrally with the second coupling member, the second lifter link extending in a direction perpendicular to a longitudinal direction of the second coupling member;
a sector gear configured to rotate integrally with the second coupling member; and
an electric motor arranged on a side opposite where the sector gear is located, with the first side frame interposed therebetween, the electric motor being configured to generate a driving force to rotate the sector gear,
wherein, in the vehicle seat, the reinforcing frame is arranged between the first side frame and the sector gear, and
wherein the reinforcing frame is provided with a displacement restricting part protruding toward the sector gear to restrict the sector gear from being displaced beyond a predetermined position.

7. The vehicle seat according to claim 6,
wherein the cushion frame further includes:
a first flange provided on a first end part, in an up-down direction, of the first side frame, the first flange protruding from the first end part in the seat-width direction; and
a second flange provided on a part of the reinforcing frame on a side opposite, in the up-down direction, where the first flange is located, the second flange protruding from said part in the seat-width direction,
wherein, in the cushion frame, when a position where the electric motor is fixed to the first side frame is referred to as a motor fixing position, the motor fixing position projected onto an imaginary horizontal plane is located inside an outer edge of the second flange projected onto the imaginary horizontal plane.

8. The vehicle seat according to claim 7,
wherein the second flange protrudes in a direction opposite to a protruding direction of the first flange.
